(19) United States
(12) Patent Application Publication
(10) Pub. No.: US 2010/0175318 A1
(43) Pub. Date: Jul. 15, 2010

(54) Plant watering system LED light and solar panel

(76) Inventor: William Ahmadi, Los Angeles, CA (US)

Correspondence Address: WILLIAM AHMADI, P.O. Box 70328, LOS ANGELES, CA, 90070, US

(21) Appl. No.: 12/315,268

(22) Filed: Dec. 2, 2008

(51) Int. Cl. A01G 9/02; F21L 4/02

(52) U.S. Cl. 47/66.6; 362/184

(57) ABSTRACT

A solar illuminated planter consists of a base of plastic or of a metallic substance that is attached to a vertical light post which is directly attached. The planter is fitted unto the base with the vertical post rising upward in the center of the interior of the planter. The vertical post is then fitted with an outer tubing of various sizes, the space created between the post and the outer tubing comprising a container for storing liquids. This outer tube is capped by plastic or metallic covering. Along the perimeter of the cap is a plurality of openings fitted with rubber hosing and encapsulating a wicking material which is netted at either end of the rubber hosing to transport moisture from the storage container to the planter. Atop the vertical light post is a brace encompassing the illumination housing wherein the LED light is housed inside a plurality of materials such as plastic, glass or lexan and gives off light for the plant and its immediate surrounding, and atop this illumination housing lies an ornamental top which houses the solar panel. The solar batteries can either be stored within the vertical light post or on the exterior of the outer container tube. This planter thus provides both self watering features and illumination features for the planter.

This application is entitled to the benefit of Provisional Patent application No. 60/965,518 filed on date Aug. 21, 2007

### FIELD OF THE INVENTION

The invention relates to a plant container and an insert able tubular water container with an LED illumination assembly attached to the base interior of the planter or the sidewall exterior of the planter along the planter wall both as nourishing light to the plant within the planter and as an ornamental decoration atop the LED assembly.

### BACKGROUND INFORMATION

### Prior Art

An in depth review of prior art reveals many different forms of illuminated planters. For example U.S. Pat. No. 7,147,342 Burnidge shows a container illuminated by a plurality of light sources by a handle. However this invention is meant to illuminate only the plant whereas the current invention is meant to illuminate the plant and the surrounding area as an ornamental display.

Many other examples of illuminated planters exist such as U.S. Pat. No. 5,741,061 Lehman on Apr. 21, 1998, U.S Jun. 15, 1999, U.S. Pat. No. 5,951,154 Carel on Sep. 14, 1999, U.S Pat. No. 6,076,940 Sanford Jr. on U.S. Pat. No. 5,879,071 Sanford Jr. on Mar. 9, 1999, U.S Pat. No. 5,911,495 Midiri on Jun. 20, 2000, U.S. Pat. No. 6,217,198 Midiri on Apr. 17, 2001 and U.S. Pat. No. 6,250,770 Countryman on Jun. 26, 2001, however none of these examples combines an illuminated planter powered by solar energy and a wick system used to transfer moisture to the planter as the current invention does.

### OBJECT

### Summary of the Invention

An object of the current invention is to provide a self watering illuminated planter whereby a decorative illumination system is produced by a planter consisting of a plurality of materials residing within a base of a plurality of materials from which the vertical light post extends upwardly, fitted atop with an LED lighting unit powered by a solar panel attached to the batteries to provide light for both the plant and the surrounding area for decorative use.

The above objects have been achieved according to the invention of a fully enclosed planter and an LED illumination system whereby the planter slides down the vertical lighting post which is directly attached to the base support in which the planter fits for the purpose of stabilization.

The vertical lighting post of plastic or metallic material can house the batteries for the unit within, or a suitable box is designed to house the batteries in a desired fashion. Atop the vertical lighting post rests the illumination member which encloses one or more LED's which are then powered by a solar panel residing within a glass or plastic enclosure about the light housing. Housed around the vertical lighting post is the outer containment tank which stores liquids and is capped at either ends. The top cap consists of a plurality of openings about the caps surface where rubber hoses are inserted at one end into the containment tank the other, is directly inserted into the soil of the planter at a desirable location and depth near the roots of the plant. liquids are delivered into the soil by means of a wick system consisting of synthetic or non synthetic material enclosed in a netting structure at either ends. From this cap also arises a vertically ascending tube one end enclosed within the containment tank the other end stands open to receive liquids to refill the containment tank.

The LED housing slides directly into the vertical lighting post by means of a brace and is topped by a plastic or metallic pyramid shade to direct the light about and around the planter.

The unique advantage of the invention is a fully self contained planter that either is standard or self watering which is illuminated by the use of solar energy. An ornamental structure sits atop the vertical lighting post and the LED lamp for a decorative effect even as the LED lamp illuminates the planters lower surroundings including light for nourishing the plant itself.

### DRAWINGS

### Brief Description of Drawings

The following should explain the invented solar LED illuminated planter in detail on the basis of the drawings.

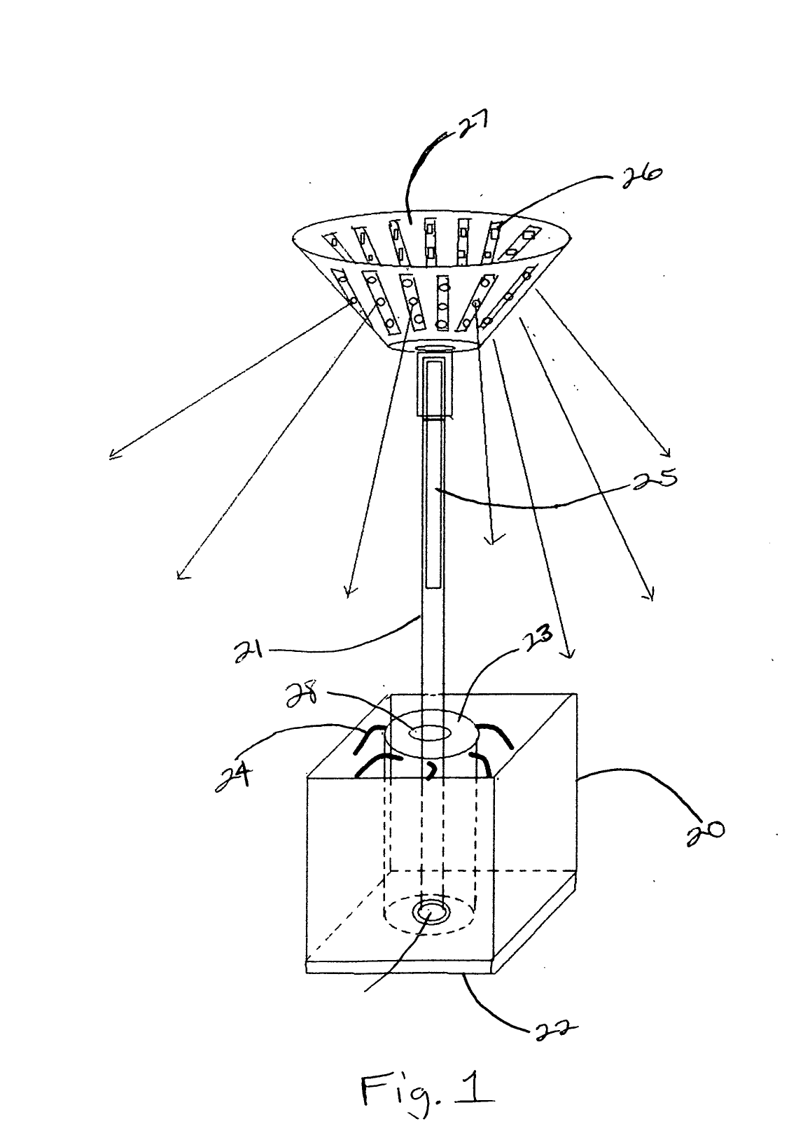

FIG. 1 is a straight forward view of the self watering solar illuminated LED planter. Geometrically it is understood that there is no difference between a front or side view.

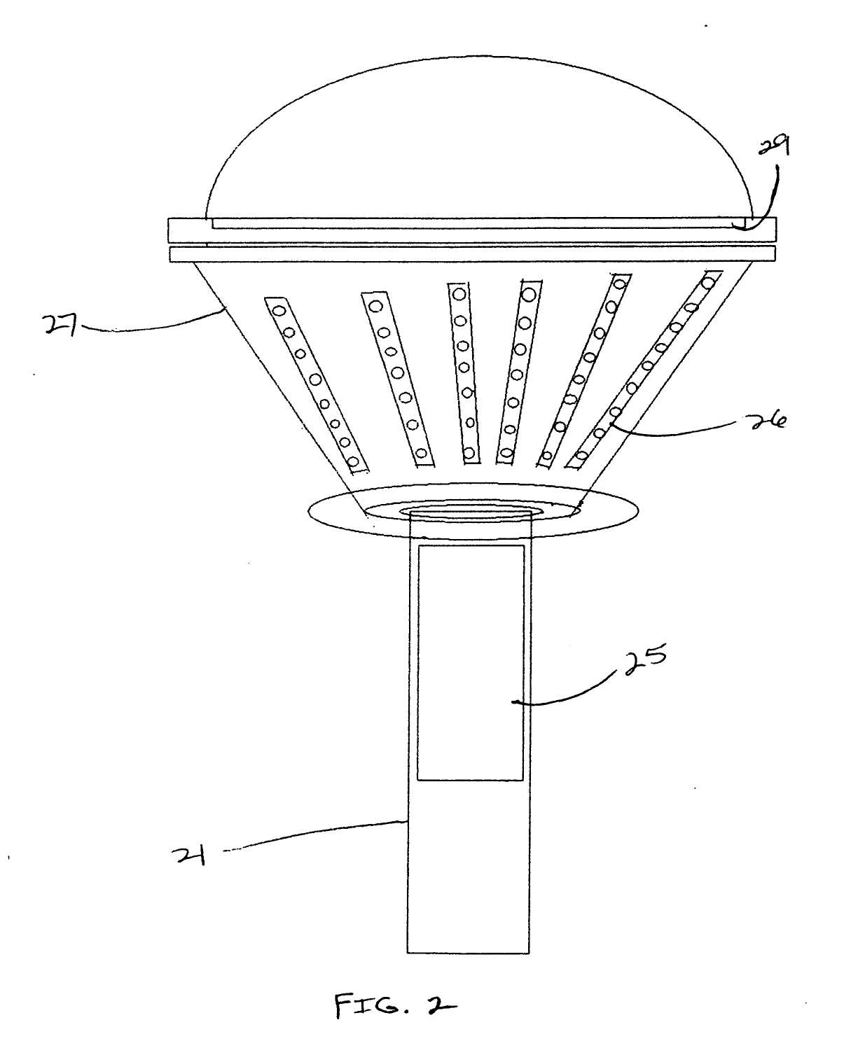

FIG. 2 is a close up view of the upper portion of the LED lighting unit

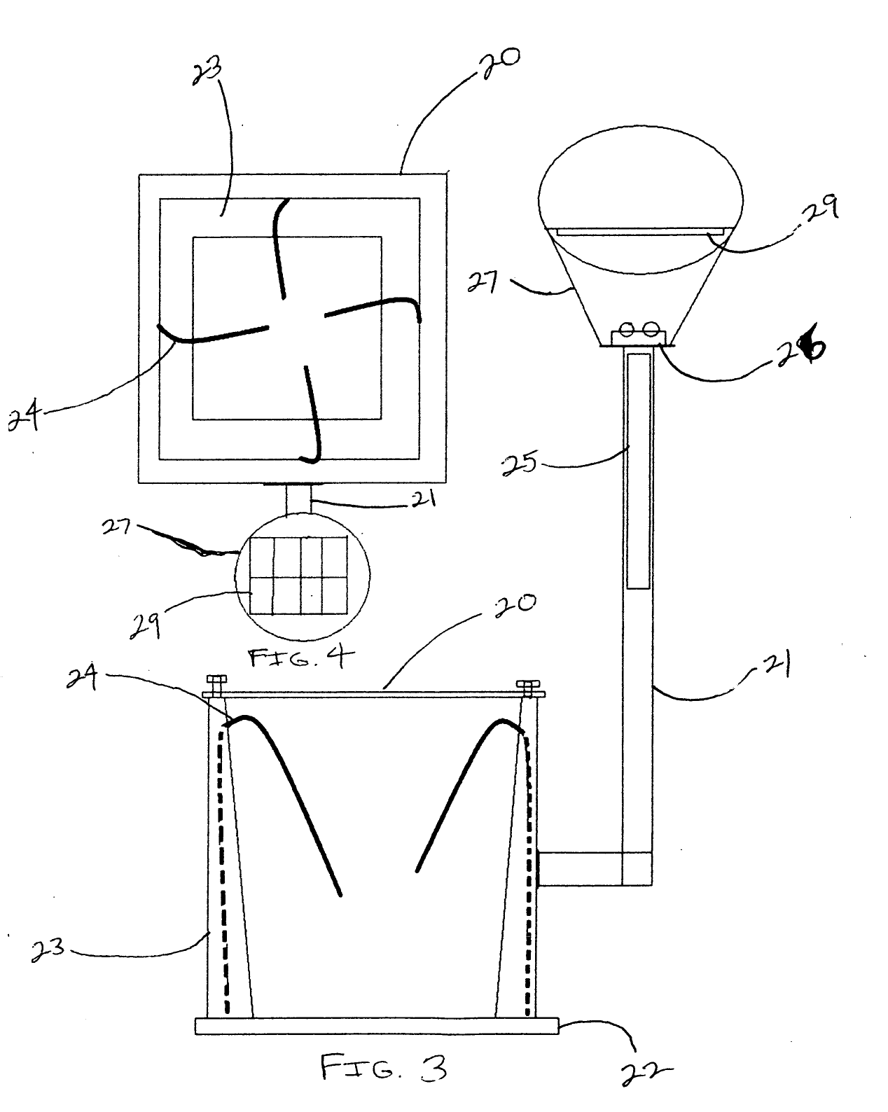

FIG. 3 is a front view of a squared surfaced planter with an alternative embodiment of the vertical lighting post on the outside of the planter.

FIG. 4 is a top view of the squared surfaced planter with an alternative embodiment of the vertical lighting post on the outside of the planter.

### DETAILED DESCRIPTION OF THE DRAWINGS

Now turning to the drawings we find in FIG. 1 a two dimensional drawing of said planters base 22 which support the added weight of the lighting unit of the present invention. The planter 20 is firmly housed within said base supporter 22, a squared shape in the present embodiment. A plurality of planter 20 and base support 22 shapes are available.

An outer containment tank 23 is mounted to said base support 22 by means of screws, nuts and bolts or welds in this embodiment of the present invention. Said containment tank 23 stores water and other needed liquids and lies in the center of said planter 20 an forms a cutout portion in its center whereby the vertical lighting post 21 is housed and connected to said base support 22. A pair of enclosure caps 28 completely seal each side of the containment tank 23 in an airtight fashion. A plurality of openings align the outer containment tank 23 wherein a plurality of wick hoses 24 extend from the containment tank 23 where water is transported by the wick hoses 24 to the planter 20. A refill spout is provided on the exterior surface of the containment tank 23 where the water source of the planter can be replenished when needed.

The aforementioned vertical light post 21 houses within the post a battery chamber 25 for the easy removal of the units batteries. Atop the light post is affixed a removable light housing 27 unit, in a plurality of shapes, sizes and materials. In the present embodiment the light housing 27 is a circular spherical shape whereby a plurality of precisely measured rectangular openings lying vertically about the light housing 27 individually secure an LED strip 26 of lights that easily slide and snap into position. Such lighting surrounds the light housing 27 in a 360 degree fashion where the circumference of the planter 20 is illuminated by said LED strips 26 of light within the light housing 27.

The light housing 27 is easily removable as it merely slides on top of the vertical lighting post 21 and is removed in the same fashion to change the batteries in said battery chamber 25.

A transparent cover encloses the top of the light housing 27 where a plurality of solar panels are embedded to absorb and transfer solar energy to the batteries within said battery chamber 25.

FIG. 2 is concerned with the lighting fixture of the self watering planter 20 with LED illumination. A transparent or translucent oval shaped lens encloses the lighting structure. A horizontally strewed Solar panel 29 is embedded within the side frame of the lens. This horizontal member is fitted onto the light housing 27 members' top enclosure.

Energy saving LED strips 26 aligns the plurality of openings along the light housing 27 frame producing a 360 degree soft glow of light. Said LED strips 26 are wired directly to said battery chamber 25 to receive energy for illumination. Similarly, the solar panel 29 is wired to a charge controller unit which is then wired to the battery chamber 25.

A vertical light post 21 acts as a housing unit for the battery chamber 25 where a floor cap is built into said vertical post 21 and is wired appropriately to send and receive energy form the solar panel 29 source to the LED strip 26 users.

An alternative embodiment is seen in FIG. 3 where the vertical light post 21 includes a 90 degree arm attachment that is affixed to the side of the planter 20. An oval shaped lens encloses a horizontal fitted solar panel 29 enclosed into an angular light housing 27 unit illuminated by a singular LED strip 26. Said vertical post 21 also houses a battery chamber 25 that illuminates the LED strip 26 and is charged by the solar panel 29.

The planter 20 is composed of an inner polystyrene wired blocks encased into cement and rests within a base support 22. A secondary surface spaced apart about that of the planter 20 encompasses said planter 20 around the area of its surface creating an outer layer where water and nutrients are stored for the plant. This outer containment tank 23 is aligned with a plurality of openings for wick hoses 24 to be placed into, along one end, with the other end placed into the planter deep at root level. Said containment tank 23 in this embodiment lies between two cement enclosure walls within said planter 20 in a circular receptacle that lines the entirety of said planter 20 and acts as a storage tank, an outer containment chamber 23 for the planters' 20 liquids.

FIG. 4 consists of a top view of said planter 20 and lighting unit. The planter is shown to possess an inner containment tank 23 within the area of said planter 20.

From above a plurality of rubber wick hoses 24 align said planter 20 delivering moisture to the plant. The horizontal arm of the vertical light post 21 is visible in this view.

A horizontal view of the light housing unit 27 is shown with an embedded solar panel 29 beneath a transparent glass or plastic receiving solar power transmitting that power to the systems battery chamber 25. The LED lights or strip 26 within illuminate the area around the planter, in addition to the planter 20 during night hours when desired.

### LIST OF DRAWING REFERENCES

20. Planter

21. Vertical light post

22. Base supporter

23. Outer containment tank

24. Wick hose

25. Battery chamber

26. LED strip

27. Light housing unit

28. Enclosure caps

29. Solar panel

### Conclusion, Ramifications, and Scope

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

I claim:

1. A solar LED illuminated planter system consisting of a metallic or plastic base housing the rim of the exterior base of the planter. The planter can easily slip into and out of said base. A vertical light post arises from either the center of the base or the exterior wall of the planter. An outer tube with a larger diameter than the light post rises vertically encapsulating said light post, the area between said post,and outer tube is used as a water container attached atop with a plurality rubber wick hoses which distribute water from to the holding tube to the planter. One opening among said hoses is fitted with a vertical tube ascending upwards used to refill the container area around the vertical post with liquids whereby said rubber wick hoses send liquids from said container to the planter. Atop the vertical post lies a brace to support the frame of the light housing member ornamental topping with a pyramid surface where inside it houses a solar panel. Within or outside the vertical post is fitted the batteries to power the LED lighting unit.

2. A solar LED illuminated planter system according to claim 1, wherein said planter can be either a standard or self watering planter.

3. A solar LED illuminated planter system according to claim 1, wherein said planter support base forms an overlapping enclosure around the base of planter, whereby planter is simply placed atop said support base. Said support base aids in stabilizing the extra weight of the vertical light post assembly on the planter.

4. A solar LED illuminated planter system according to claim 1, wherein said vertical light post is directly attached to the support base by means of welds or screws and forms one piece whereby the planter contains a cutaway in a plurality of shapes at the center of its base and slides directly over said vertical light post and into the support base. Said vertical light post comes in a plurality of shapes.

5. A solar LED illuminated planter system according to claim 1, wherein said vertical light post supports an LED light housing, in a plurality of shapes affixed atop said light post by a metallic or plastic brace an encompasses an LED light source. A circular ring of plastic or rubber fits atop the LED light housing, and attached to said ring ties a metallic or plastic lamp shade where the solar panel is embedded.

6. A solar LED illuminated planter system according to claim 5, wherein said LED light housing is internally directly wired from the LED light source to the internal batteries. Said light housing is directly removable from atop of the vertical light post.

7. A solar LED illuminated planter system according to claim 1, said vertical light post is attached to the outside sidewall of the planter in the form of an L arm.

8. A solar LED illuminated planter system according to claim 1, wherein said outer tube container comes in a plurality of diameters and fits directly over the vertical light post, the area between said outer tubing and inner light post creating a sealed containment where liquid is stored to nourish the planter.

9. A solar LED illuminated planter system according to claim 8, wherein said outer tubing is affixed atop by an enclosure which consists of a plurality of openings whereby flexible rubber wicking hoses descend into the containment area on one end to draw liquids down into the planter. Said rubber wicking hoses are placed about the planter and inserted into said planter at a desirable depth and location near the plants root system. A vertical refill opening ascends from the containment tube, up through the cap, and is used to replenish the liquids of the containment area. Said tubing is sealed around the vertical light post which passes through along either the base or top sides.

10. A solar LED illuminated planter according to claim 9, wherein said rubber wicking hoses are serviceable and descend from the containment tube into the planters soil and transfers liquids via capillary action using wicking materials that are either synthetic or non synthetic that are enclosed in a netting material to aid capillary action.

11. A solar LED illuminated planter according to claim 1, wherein said batteries are stored either within the vertical light posts interior or inside a box along the body of the outer post at a desirable location.
